(19) United States
(12) Patent Application Publication
(10) Pub. No.: US 2011/0179260 A1
(43) Pub. Date: Jul. 21, 2011

(54) METHOD FOR INTEGRATING OPERATING SYSTEM INTO BIOS CHIP AND METHOD FOR BOOTING OPERATING SYSTEM FROM SERVER

(75) Inventors: DE-YUAN DONG, Shenzhen City (CN); DONG-HAI XUE, Shenzhen City (CN); XIA WANG, Shenzhen City (CN); MEI-PENG SHE, Shenzhen City (CN)

(73) Assignees: HONG FU JIN PRECISION INDUSTRY (Shenzhen) CO., LTD., Shenzhen City (CN); HON HAI PRECISION INDUSTRY CO., LTD., Tu-Cheng (TW)

(21) Appl. No.: 12/797,751

(22) Filed: Jun. 10, 2010

(30) Foreign Application Priority Data
Jan. 21, 2010 (CN) 201010300525.9

(51) Int. Cl. G06F 15/177; G06F 9/00; G06F 9/24

(52) U.S. Cl. 713/2; 713/1

(57) ABSTRACT

A method for integrating an operating system (OS) into a basic input output system (BIOS) chip and to boot a computer system using an image file stored in a server. A bootable image file of the OS is integrated with a virtual disk program and other BIOS instructions and stored into the BIOS chip. When the computer system is powered up, the OS stored in the BIOS can be booted to allow the another OS stored in the server to be downloaded into the harddisk and executed. The BIOS OS can also allow an OS stored on the local drive to be executed.

### CROSS-REFERENCE TO RELATED APPLICATION

Relevant subject matter is disclosed in one co-pending U.S. patent application (Attorney Docket No. US29196), which is assigned to the same assignee as this patent application.

### BACKGROUND

1. Technical Field

The present disclosure relates to a method for integrating an operating system into a BIOS chip, and a method for booting an operating system stored in a server.

2. Description of Related Art

When a computer system is powered on or reset, a central processing unit (CPU) executes booting program, such as basic input output system (BIOS) stored in the BIOS chip. The BIOS initializes hardware components and performs a power on self test (POST, an optional function). If no error occurs during the POST, an operating system stored in an auxiliary storage, such as a hard disk, is booted. Therefore, when the operating system stored in the hard disk is damaged, the computer system cannot work.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a flowchart of an exemplary embodiment of a method for integrating an operating system into a basic input output system (BIOS) chip.

FIG. 2 is a flowchart of an exemplary embodiment of a method for booting an operating system from a server.

### DETAILED DESCRIPTION

The disclosure, including the accompanying drawings in which like references indicate similar elements is illustrated by way of example and not by way of limitation. It should be noted that references to “an” or “one” embodiment in this disclosure are not necessarily to the same embodiment, and such references mean at least one.

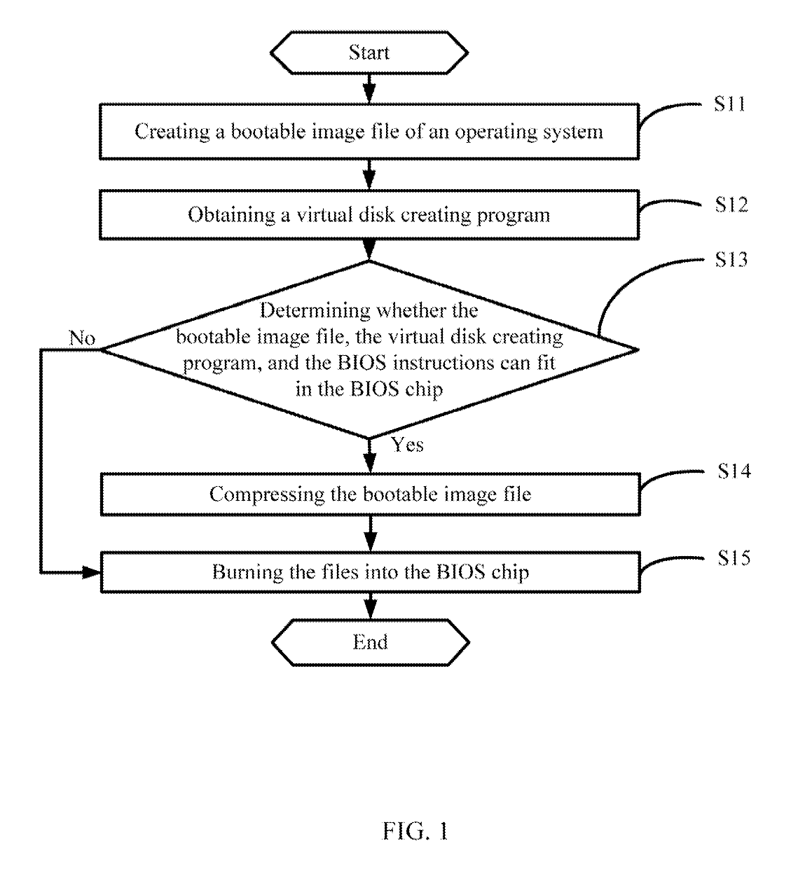

Referring to FIG. 1, an exemplary embodiment of a method for integrating an operating system (OS) into a basic input output system (BIOS) chip includes the following steps.

In step S11, a bootable image file of the OS is created. In the embodiment, the OS may be a LINUX OS. Essential, and base on need, selective modules are included in the kernel of the LINUC OS. Local area network driver modules and net configuration tool modules are included in the kernel.

In step S12, virtual disk codes are compiled to obtain a virtual disk creating program. When the virtual disk creating program is executed, an area in memory emulates a physical disk drive.

In step S13, a determination is made on whether the bootable image file, the virtual disk creating program, and the BIOS instructions, such as programs for power on self test (POST) can fit in the BIOS chip or not. Upon the condition that the bootable image file, the virtual disk creating program, and the BIOS instructions cannot fit in the BIOS chip, the process flows to step S14. Upon the condition that the bootable image file, the virtual disk creating program, and the BIOS instructions can fit in the BIOS chip, the process flows to step S15.

In step S14, the bootable image file is compressed to reduce the file size. The process flows to step S15.

In step S15, the bootable image file, the virtual disk creating program, and the BIOS instructions, or the compressed bootable image file, the virtual disk creating program, and the BIOS instructions are burned into the BIOS chip. Thus the OS is integrated into the BIOS chip.

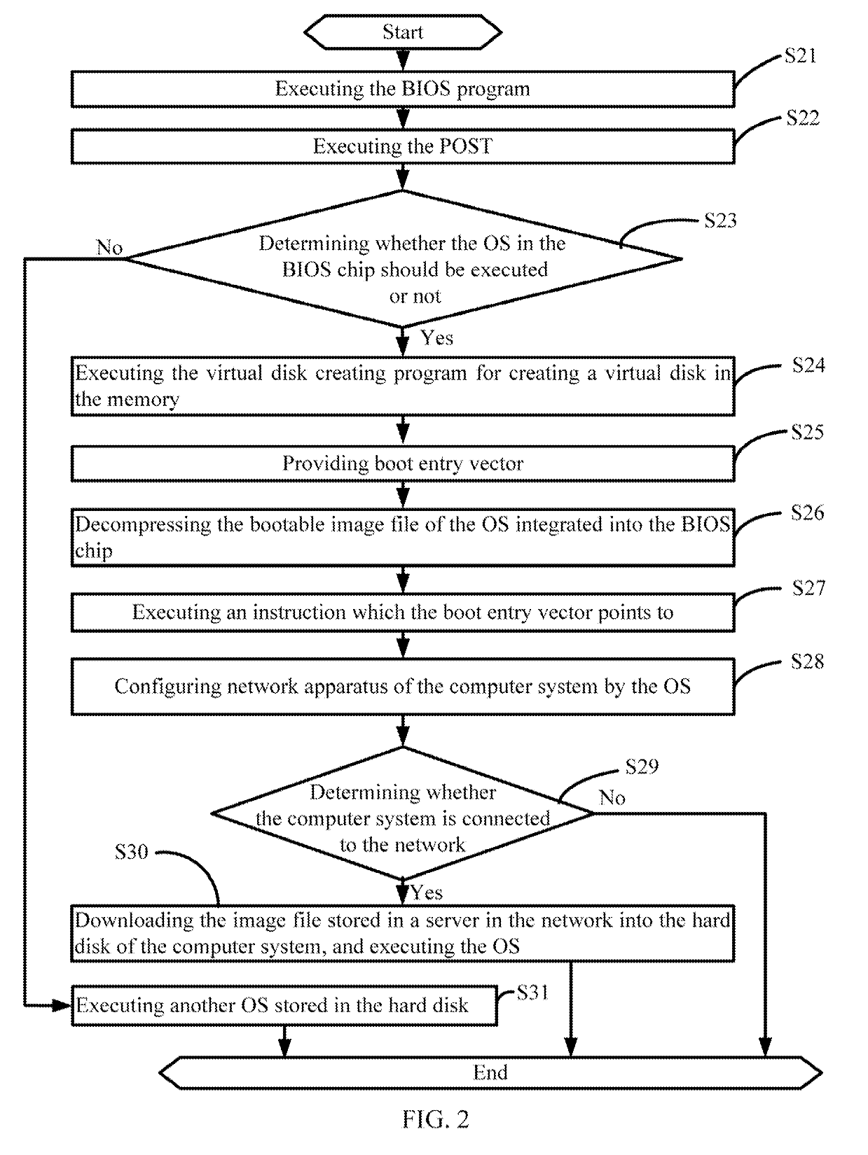

Referring to FIG. 2, after the step S15 of “the OS is integrated to the BIOS chip” of FIG. 1, the method for booting another operating system stored in a server further includes the following steps.

In step S21, when the computer system is powered on, a power supply supplies voltage to a motherboard, a central processing unit (CPU), and other components, such as a memory of the computer system, then the computer system is powered on and the BIOS program is executed.

In step S22, the POST is executed for determining whether key components, such as a hard disk and memory, in the computer system work or not. Upon the condition that one of the key components in the computer system cannot work, the computer system fails POST and cannot boot.

In step S23, upon the condition that all the key components in the computer system can work, that is, namely POST test passes, a determination is made on whether the OS in the BIOS chip should be executed or not. Upon the condition that the OS in the BIOS chip is to be executed, the process flows to step S24. Upon the condition that the OS in the BIOS chip need not be executed, the process flows to step S31. It can be understood that the determination of whether the OS in the BIOS chip should be executed or not is made by detecting whether a preset key for starting the OS is pressed. When the preset key is pressed after POST passes, it denotes that the OS in the BIOS chip should be executed. Otherwise, it denotes that the OS in the BIOS chip should not be executed. In other embodiments, the determination of whether the OS in the BIOS chip should be executed or not can be made by detecting an interactive input during the POST, for example, “F2” key or other keys according to a type of the motherboard is pressed during the POST to determine whether the user needs to setup the BIOS configuration.

In step S24, the virtual disk creating program are executed for creating a virtual disk in the memory. The virtual disk is marked as OS MEM. In the embodiment, the virtual disk OS MEM is specialized for the BIOS chip by amending data of BIOS Data Area, an E820 table, and an Advanced Configuration and Power Management Interface (ACPI). In other words, the virtual disk OS MEM stores only data from the BIOS chip.

In step S25, a boot entry vector (BEV) is provided to the BIOS program. The boot entry vector points to an initial address of the virtual disk OS MEM.

In step S26, the bootable image file of the OS integrated into the BIOS chip is decompressed, and stored in the virtual disk OS MEM.

In step S27, an instruction pointed to by the boot entry vector is executed. Because the virtual disk OS MEM stores the decompressed image file, an initial instruction of the decompressed image file is executed. Thus, the OS in the BIOS chip is executed.

In step S28, network apparatus, such as a network card of the computer system is configured by the OS.

In step S29, a determination is made on whether the computer system is connected to the network. Upon the condition that the computer system is not connected to the network, the process ends. Upon the condition that the computer system is connected to the network, the process flows to step S30. In the embodiment, the network may be a local area network or a wide area network. A server which stores a bootable image file of another OS, exists in the network. The server may be a “Cloud” server.

In step S30, the bootable image file of the another OS is downloaded into the hard disk of the computer system from the server in the network, then the OS can be executed. Because the server has a larger space than the BIOS chip, the OS stored in the server has more modules than the OS integrated into the BIOS chip.

In step S31, an OS stored in the hard disk is executed.

As described above, the LINUX OS is integrated into the BIOS chip. When the OS stored in the hard disk is damaged, the LINUX OS integrated in the BIOS chip is executed, and thus an OS stored in the server is executed.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A method for integrating an operating system into a basic input output system (BIOS) chip, the method comprising:
creating a bootable image file of the operating system, wherein local area network driver modules and net configuration tool modules are included in the kernel of the operating system;
compiling virtual disk codes to obtain a virtual disk creating program; and
integrating the bootable image file of the operating system and the virtual disk creating program into the BIOS chip.

2. The method of claim 1, after the step of “compiling virtual disk codes to obtain a virtual disk creating program”, further comprising:
determining whether the bootable image file, the virtual disk creating program, and BIOS instructions can or cannot fit into the BIOS chip; and
compressing the image file to reduce the file size, upon the condition that the bootable image file, the virtual disk creating program, and BIOS instructions cannot fit the BIOS chip.

3. A method for booting a first operating system from a server, the method comprising:
executing basic input output system (BIOS) program;
executing power on self test (POST);
determining whether a second operating system in the BIOS chip should be executed or not;
executing a virtual disk creating program for creating a virtual disk in a memory of the computer system upon the condition that the second operating system in the BIOS chip should be executed;
providing a boot entry vector, wherein the boot entry vector points to an initial address of the virtual disk;
storing a bootable image file of the second operating system which is integrated into the BIOS chip into the virtual disk;
executing the second operating system;
configuring network apparatus of the computer system by the second operating system; and
downloading a bootable image file of the first operating system stored in the server into a hard disk of the computer system, and executing the first operating system.

4. The method of claim 3, wherein immediately after the step of “determining whether a second operating system in the BIOS chip should be executed or not” and upon the condition that the second operating system should not be executed, a third operating system stored in the hard disk is executed.

5. The method of claim 3, between the step of “configuring network apparatus of the computer system by the second operating system” and the step of “downloading a bootable image file of the first operating system stored in the server into a hard disk of the computer system, and executing the first operating system”, further comprising:
determining whether the computer is connected or not connected to a network where the server exists; and
upon the condition that the computer is connected to the network, the step of “downloading a bootable image file of the first operating system stored in the server into a hard disk of the computer system, and executing the first operating system” is executed.
